(19) United States
(12) Patent Application Publication
(10) Pub. No.: US 2015/0301635 A1
(43) Pub. Date: Oct. 22, 2015

(54) INFORMATION PROCESSING DEVICE, INFORMATION PROCESSING METHOD, AND PROGRAM

(71) Applicant: HITACHI MAXELL, LTD., OSAKA (JP)

(72) Inventor: Nobuo MASUOKA, Ibaraki (JP)

(73) Assignee: Hitachi Maxell, Ltd., Ibaraki-shi, Osaka (JP)

(21) Appl. No.: 14/651,244

(22) PCT Filed: Jan. 15, 2013
(86) PCT No.: PCT/JP2013/050508

§ 371 Date: Jun. 11, 2015

(51) Int. Cl. G06F 3/041; G06F 3/0488; G06F 3/0484

(52) U.S. Cl. CPC G06F 3/041; G06F 3/04845; G06F 3/0488

(57) ABSTRACT

The information processing device is provided with a display unit which displays an image, and operation input unit to which a user operation is input, and a control unit; wherein the control unit, upon detecting a touching of a finger of a user to the operation input unit, displays a mark at the detected position, and in a state in which the mark is displayed, in a case in which a touching of a finger of the user is detected at a position different from the position of the mark, if the touch position changes to a direction extending away from the position of the mark, magnifies the display image on the display unit, and if the touch position changes to a direction approaching the position of the mark, performs control minimizing the display image of the display unit.

### TECHNICAL FIELD

The present invention relates to an information processing device, an information processing method and program.

### BACKGROUND ART

A prior art of the present technical field is Japanese Patent Application Laid-Open No. 2000-163031 (PTL 1). This publication recites that “it is an electronic book including a display unit capable of displaying map images, and it is possible to simultaneously input an execution instruction of at least one of magnifying (zoom in) or reducing (zoom out) a map image and an operation amount through operation history of fingers made to contact the display unit. It is possible to input an magnifying instruction and an amount of magnification of the map image through operations of separating two fingers. Further, it is possible to input a reducing instruction and an amount of reduction of the map image through operations of approaching two fingers.” (see abstract).

### CITATION LIST

### Patent Literature

PTL 1: Japanese Patent Application Laid-Open No. 2000-163031

### SUMMARY OF INVENTION

### Technical Problem

Operation methods of magnifying/reducing processes of display images in a conventional information processing device 100′ as recited in PTL 1 will be explained using FIG. 6. In the conventional information processing device 100′, fingers 201, 202 (here a thumb and an index finger) of a right hand 200 are made to simultaneously touch a touch panel 118′ as shown in FIG. 6. Touch positions of the fingers 201, 202 are defined to be point X and point Y, respectively. When the two fingers 201, 202 are moved in a separating direction (pinch-out), distance XY becomes larger and magnification ratios of the display image are successively increased in accordance with the movements. Further, when the two fingers 201, 202 are moved in an approaching direction (pinch-in), the distance XY becomes smaller and reduction ratios are successively reduced in accordance with the movements. In this manner, magnifying/reducing processes are performed in accordance with changes in distances of two fingers touching the touch panel, and such operations are advantageously intuitive, easy to understand and easy to use.

However, in the conventional information processing device 100′, since two fingers are used for operation, operations of pinch-out/pinch-in need to be performed with the right hand while holding the information processing device 100′ with the left hand 210 as shown in FIG. 6, and operations can be performed easiest when using both hands.

In these days, downsizing, weight reduction and improved performances are achieved for information processing devices, and they are increasing used not only indoors but also outdoors such as at visit destinations or in trains. In such cases, it might happen that only one hand in available since the other hand holds a bag or a hanging strap in a train. In such situations, there is a possibility that operations of pinch-out and pinch-in can hardly be performed by holding the device in one hand and using two fingers of the other hand.

### Solution to Problems

For solving the above problems, the configuration recited in, for instance, the claims is employed.

While the present invention includes a plurality of solutions to the above problems, one example thereof is an information processing device comprising a display unit for displaying images, an operation input unit for inputting user operations, and a control unit, wherein when it is detected that a finger of a user has touched the operation input unit, the control unit displays a mark on the detected spot, and when it is detected that a finger of the user has touched another position different from the position of the mark in a state in which the mark is displayed, control is performed to magnify the display image of the display unit when the touch position changes in a direction separating from the position of the mark, and to reduce the display image of the display unit when the touch position changes in a direction approaching the position of the mark.

### Advantageous Effects of Invention

According to the present invention, it is possible to provide an information processing device and others that is easy to use. Problems other than the above described, configurations and effects will become apparent from the following explanations of embodiments.

### BRIEF DESCRIPTION OF DRAWINGS

FIG. 1 is a block diagram showing an internal configuration example of an information processing device.

FIGS. 2A, 2B are explanatory views for setting a pinch mark.

FIGS. 3A-3F are explanatory views of operation methods for performing pinch-out/pinch-in.

FIGS. 4A, 4B are explanatory views of processes for deleting a pinch mark.

FIGS. 5A-5C are explanatory views of processes for changing a pinch mark position.

FIG. 6 is an explanatory view of operation methods for performing pinch-out/pinch-in in a conventional device.

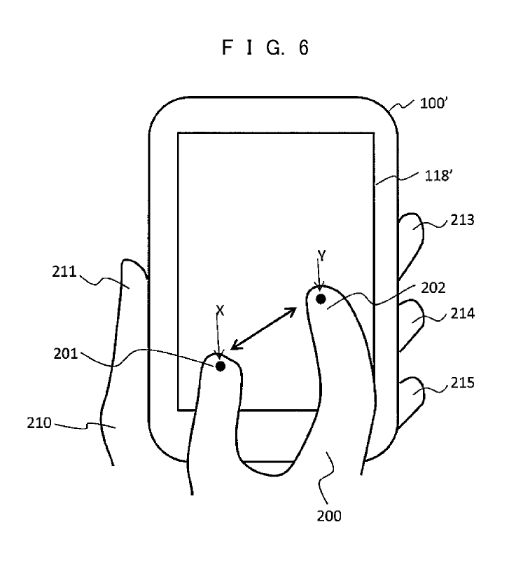

### DESCRIPTION OF EMBODIMENTS

Embodiments will now be explained using drawings.

### Example 1

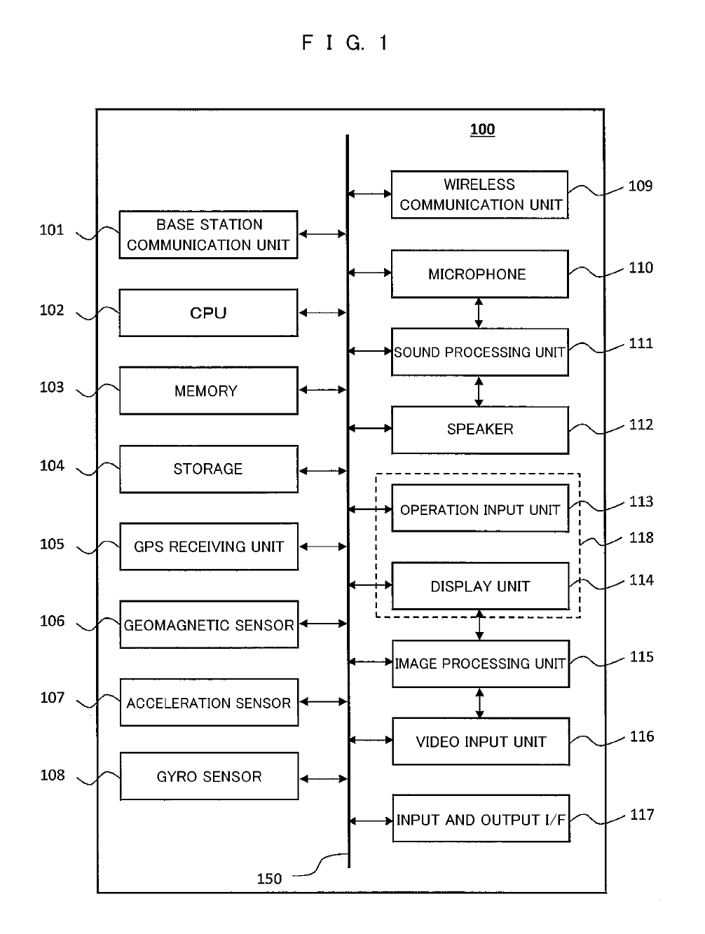

FIG. 1 is a block diagram showing an internal configuration example of an information processing device 100 according to one example of the present invention.

Here, explanations will be made by taking a case of a smartphone as an example. The information processing device 100 comprises a base station communication unit 101, a CPU 102, a memory 103, a storage 104, a GPS (Global Positioning System) receiving unit 105, a geomagnetic sensor 106, an acceleration sensor 107, a gyro sensor 108, a wireless communication unit 109, a microphone 110, a sound processing unit 111, a speaker 112, an operation input unit 113, a display unit 114, an image processing unit 115, a video input unit 116, an input and output I/F 117 and a touch panel 118, and each of them are mutually connected to a bus 150.

The base station communication unit 101 is a communication interface which performs long-distance wireless communication with base stations (not shown) such as W-CDMA (Wideband Code Division Multiple Access) or GSM (registered trademark) (Global System for Mobile Communications) or the like.

The CPU 102 controls respective components and performs various processes by executing programs stored in the memory 103.

The memory 103 is, for instance, a flash memory and stores therein programs and data. Programs stored in the memory 103 can be updated and added at any time by downloading them from external servers (not shown) or the like with the base station communication unit 101 performing wireless communication with base stations. Further, the information processing device 100 comprises the storage 104 such as a memory card or the like, and data can be stored also in the storage 104.

The GPS receiving unit 105 is for receiving signals from GPS satellites up in the sky. With this arrangement, it is possible to detect current positions of the information processing device 100.

The geomagnetic sensor 106 is a sensor for detecting directions in which the information processing device 100 faces.

The acceleration sensor 107 is a sensor for detecting accelerations of the information processing device 100, and the gyro sensor 108 is a sensor for detecting angular velocities of the information processing device 100. With these arrangements, it is possible to detect inclinations and movements of the information processing device 100 in details.

The wireless communication unit 109 is a communication interface for performing wireless communication using wireless LANs such as IEEE802.11a/b/n.

The microphone 110 is for inputting external sounds and the speaker 112 is for outputting sounds to the exterior. The input and output sounds undergo sound processing in the sound processing unit 111.

The touch panel 118 is comprised of the operation input unit 113 and the display unit 114. The display unit 114 is, for instance, a LCD for displaying videos or images, and its display surface includes the operation input unit 113 such as a touch pad.

The operation input unit 113 is a touch pad of, for instance, electrostatic capacitance type for detecting contact operations using fingers or touch pens (hereinafter referred to as “touch”) as operation inputs. For instance, by displaying a menu of commands (functions) on the display unit 114 and a user selecting desired commands through touch, the touch positions are detected to accept commands displayed at the touch positions. It is also possible to recognize touch or touch operations such as tap, flick or pinch-out/pinch-in in a state in which images are displayed on the display unit 114. The touch or touch operations accepted at the operation input unit 113 are input to and processed by the CPU 102.

The video input unit 116 is, for instance, a camera. Videos displayed on the display unit 114 or videos input from the video input unit 116 are processed by the image processing unit 115.

The input and output I/F 117 is, for instance, a USB (Universal Serial Bus) and is an interface which performs transmission and reception of data with external devices (not shown).

Operation methods for pinch-out/pinch-in in the information processing device 100 of the present embodiment will now be explained.

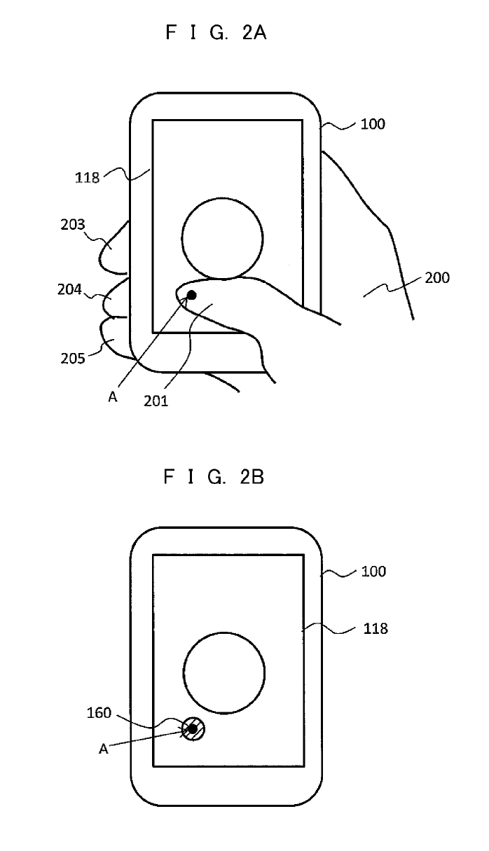

First, setting of a pinch mark which is an initial operation of pinch-out/pinch-in operations will be explained using FIG. 2A, 2B. In this respect, the device is normally in a mode of accepting pinch-out/pinch-in operations using two fingers similarly to the conventional information processing device 100′, and for performing processes of the present embodiment, it is necessary to preliminarily switch to the processing mode of the present embodiment through command operations or the like.

As shown in FIG. 2A, in a state in which an image is displayed on the touch panel 118, a proximity (point A) of a portion which the user wants to magnify/reduce is tapped. Here, “tapping” indicates an operation of patting one point on the touch panel wherein a touch start position and a touch end position are substantially identical. Further, as shown in FIG. 2A, it is supposed that the information processing device 100 is held with one hand 200 (here, the right hand) and tapping is performed using a finger 201 (here, the thumb) of the hand 200.

The operation input unit 113 detects coordinates of the point A, stores them in the memory 103, and displays a mark 160 to overlap the original image at the position of the point A (FIG. 2B). In the following explanations, mark 160 is referred to as “pinch mark” while point A is referred to as “pinch position”.

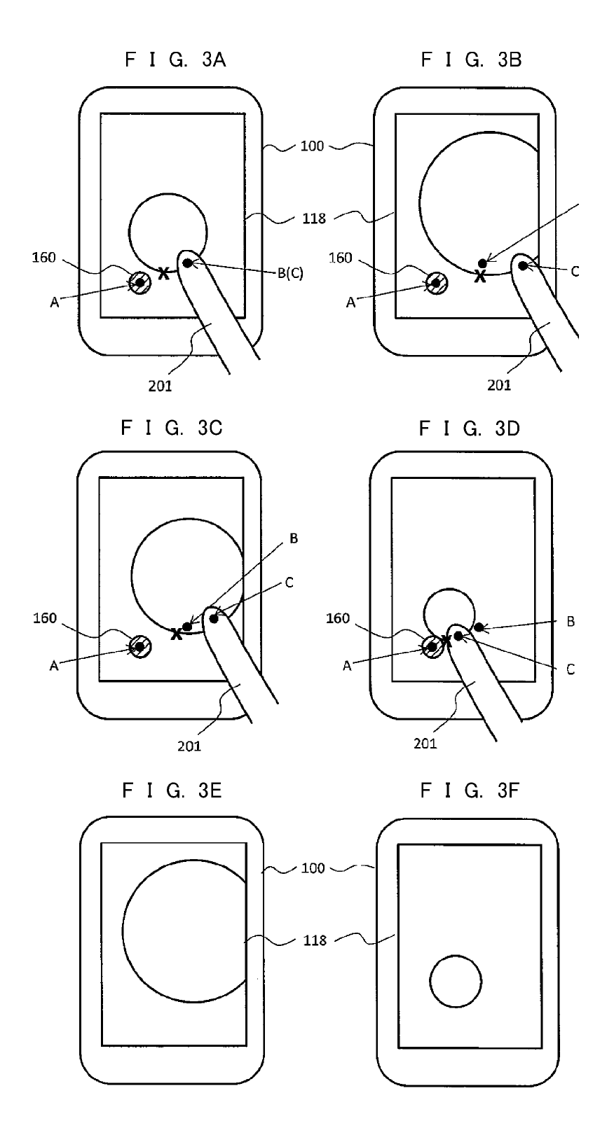

Operation methods of pinch-out/pinch-in will now be explained using FIG. 3A-3F.

As shown in FIG. 3A, the finger 201 touches a position opposing point A of a portion to be magnified/reduced. In this respect, fingers holding the information processing device 100 will not be shown in the drawings hereinafter for the sake of simplification. This start position of touch is defined to be point B. The operation input unit 113 detects coordinates of the point B and stores them in the memory 103. At this time, distance AB between the pinch position (point A) and the touch start position (point B) and a middle point (point X) between the pinch position (point A) and the touch start position (point B) on the display image are preliminarily calculated.

Next, the finger 201 is slid in an arbitrary position. A sliding operation is an operation in which the touch position is moved while maintaining the touching state. Here, the point the finger 201 is touching is defined to be point C, and the operation input unit 113 successively detects coordinates of point C and stores them in the memory 103. In this respect, since FIG. 3A shows a state at the start of touch, the touch start position (point B) and the touch position (point C) are the same positions.

FIG. 3B shows a case in which the finger 201 is slid in a direction separating from the pinch position (point A). This can be discriminated by calculating distance AC between the pinch position (point A) and touch position (point C), and by comparing it with the above distance AB. Namely, it can be discriminated that the finger is sliding in a direction separating from the pinch position (point A) since distance AC>distance AB is satisfied.

As shown in FIG. 3B, when the finger 201 is slid in a direction separating from the pinch position (point A), the display image is scrolled such that the middle point (point X) on the display image is approximately the center of the pinch position (point A) and the touch position (point C), and image processing is performed to magnify the image with the center being the middle point (point X). At this time, the distance AC and the magnification ratio are linked. Namely, the more the finger 201 separates from the pinch position (point A), the bigger the magnification ratio becomes.

When the finger 201 is slid to return it in a direction approaching the pinch position (point A) to move from the state of FIG. 3B to the state of FIG. 3C, the distance AC of FIG. 3C becomes smaller than the distance AC of FIG. 3B, and the magnification ratio become smaller when compared to the state of FIG. 3B as shown in FIG. 3C. In this respect, since distance AC>distance AB is satisfied in the example of FIG. 3C, the display image is magnified when compared to the initial image of FIG. 3A.

Further, the display image when the finger 201 is slid in a direction approaching the pinch position (point A) to satisfy distance AC<distance AB as shown in FIG. 3D is a reduced image when compared to the initial image of FIG. 3A. In this respect, also in case distance AC<distance AB is satisfied, the distance AC and the reduction ratio are linked, and the more the finger 201 approaches the pinch position (point A), the bigger the reduction ratio becomes.

In this manner, since magnification ratios/reduction ratios of display images successively change in accordance with movements of the finger 201, the user can easily set display images to desired sizes through one-handed operations.

For terminating processes of pinch-out/pinch-in, the finger 201 shall be lifted from the touch panel 118. For instance, when the finger 201 is lifted from the touch panel 118 in the state of FIG. 3B, the display image is set at the current magnification ratio as shown in FIG. 3E, the pinch mark 160 is deleted and the present processes are terminated. Further, for instance, when the finger 201 is lifted from the touch panel 118 in the state of FIG. 3D, the display image is set at the current reduction ratio as shown in FIG. 3F, the pinch mark 160 is deleted and the present processes are terminated.

In this respect, while the pinch mark 160 is deleted and processes are terminated at a point of time at which the finger 201 is lifted from the touch panel 118 in the above explanations, the present invention is not limited to this. For instance, it is also possible to maintain a state in which the pinch mark 160 is displayed for a predetermined time (for instance, 5 seconds) after lifting the finger 201 from the touch panel 118, and to enable pinch-out/pinch-in operations by repeatedly touching and sliding the finger 201.

Further, while an example has been explained above in which the finger 201 is first slid in a direction separating from the pinch position (point A) and then slid in a direction approaching the pinch position (point A) in the above explanations, the present invention is not limited to this. For instance, when the finger 201 is slid from the state of FIG. 3A in a direction approaching the pinch position (point A), the state of FIG. 3D is assumed, and when the finger is lifted at this point, the state of FIG. 3F is assumed. That is, the display image will be a reduced image when compared to the initial image of FIG. 3A. It is also possible not to lift the finger 201 but to slide it further in a direction separating from the pinch position (point A). As long as the finger 201 is in contact, touch positions (points C) are continuously detected to calculate distances AC, and magnification/reduction is discriminated by comparing them with distances AB, magnification ratios/reduction ratios are determined in accordance with distances AC, and images are displayed at these magnification ratios/reduction ratios with centers being coordinates (points X) on display images. Simultaneously, display images are scrolled such that the coordinates (points X) on the display images will be approximately the centers of the pinch positions (points A) and touch positions (points C).

Further, it is also possible to make the processes of the present embodiment function in case the display images can be displayed in magnified/reduced form such as maps or photos. For instance, processes of the present embodiment are not performed when no magnified/reduced displays are necessary such as in cases of accepting commands upon displaying a menu on the touch panel 118 or at the time of text entry, and normal tap processes (selection or the like) are performed. It is also possible to display a mark indicating that magnified/reduced displays are possible in case of display images which can be displayed in magnified/reduced form.

Moreover, while the present embodiment has been explained based on an example in which magnification/reduction is performed with the centers being the middle points X between the pinch positions (points A) and touch positions (points C), it is also possible to perform magnification/reduction with the center being the pinch positions (points A). At this time, magnified/reduced display is performed upon coinciding points A on the display image and pinch positions (points A).

Next, a method for deleting the pinch mark 160 will be explained.

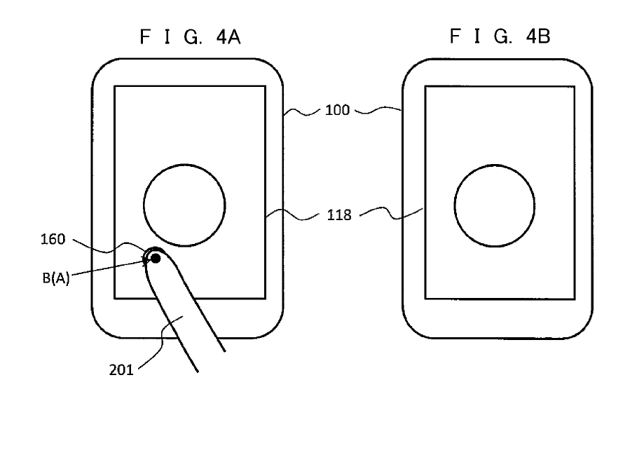

FIG. 4A, 4B is an explanatory view of processes for deleting the pinch mark 160. These processes are employed when the touch panel 118 is erroneously tapped to cause a display of the pinch mark 160. As shown in FIG. 4A, the pinch mark 160 is tapped. At this time, a touch start position (point B) is detected, and when a distance thereof to a pinch position (point A) is within a predetermined value (for instance, 1 mm), it is determined that the pinch position (point A) has been tapped, and the pinch mark 160 is deleted while the display image remains unchanged as shown in FIG. 4B. In this respect, while the pinch mark 160 is deleted when the pinch mark 160 is tapped in the above explanations, it is also possible to automatically delete the pinch mark 160 when no operations have been made within a predetermined time (for instance, 5 seconds) in a state in which the pinch mark 160 is displayed. It is also possible to provide a mechanical operation button (not shown) such as a push button or a slide button in the information processing device 100, and to delete the pinch mark 160 when the operation button is operated.

Next, a method for changing a position of the pinch mark 160 will be explained.

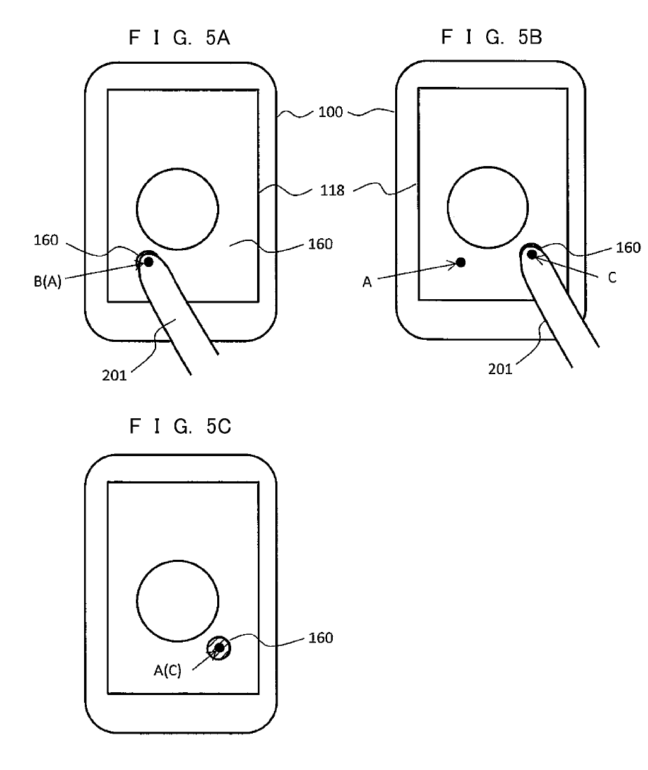

FIG. 5A-5C is an explanatory view of processes for changing a position of the pinch mark 160. As shown in FIG. 5A, the pinch mark 160 is touched. Similar to the above deleting processes, a touch start position (point B) is detected, and when a distance thereof to a pinch position (point A) is not more than a predetermined value, it is determined that the pinch position (point A) has been touched. In this state, the finger 201 is slid as shown in FIG. 5B. The touch position (point C) at this time is detected, and the pinch mark 160 is moved to the touch position (point C). When the finger 201 is slid to a desired position and the finger 201 is lifted from the touch panel 118, the position (point C) at which the finger 201 has been lifted is made to be the new pinch position (point A) as shown in FIG. 5C.

In this respect, while an example has been explained above in which the pinch position (point A) is moved by sliding the finger 201, it is also possible to move the pinch position (point A) and to scroll the display image by sliding the finger 201.

As explained above, it is possible to easily make a pinch mark 160 be displayed at a tapped position by merely tapping the touch panel 118. When the touch panel 118 is touched and slid in a state in which the pinch mark 160 is displayed, it is possible to perform pinch-out/pinch-in operations in linkage with the movements of the finger, so that it is possible to easily perform magnifying/reducing operations of the display images also in situations in which only one hand can be used. Further, since the pinch mark 160 can be deleted by tapping the pinch mark 160 and the position of the pinch mark 160 can be changed by touching and sliding the pinch mark 160, it is also possible to easily perform deletion and changing positions of the pinch mark 160 with one hand.

In this respect, while an example has been explained above in which the information processing device 100 is held with the right hand 200 and operations are performed by the thumb 201 of the right hand 200, the present invention is not limited to this. For instance, it is also possible to perform holding and operations with the left hand 210 and it is also possible to perform operations using another finger (such as an index finger).

Further, while an example has been explained above in which the device is normally in a mode of performing pinch-out/pinch-in operations using two fingers as in conventional devices, meanwhile it can be switched to a mode of the present embodiment performing pinch-out/pinch-in operations using one finger through command operations, the present invention is not limited to this. It is, for instance, possible that the device is normally in a mode in which pinch-out/pinch-in operations are performed using two fingers as in conventional devices, and tap operations in which the time of contact with the touch panel 118 is short are accepted as normal tap operations, while in case of long-pressing operations in which the time of contact is, for instance, not less than 1 second, the processes of the present embodiment are performed and positions at which long-pressing operations have been made could be the pinch positions. That is, it is not necessary to switch between modes of conventional pinch-out/pinch-in operations and the pinch-out/pinch-in operations of the present embodiment, and the processes of the present invention shall be performed in case long-pressing operations are made. In this respect, the present invention is not limited to long-pressing operations, but processes of the present embodiment might also be performed, for instance, upon double-tap operations in which tap operations are performed twice within a predetermined time (for instance, 1 second). In this case, when the second tap position is apart from the first tap position by not less than a predetermined distance (for instance, 1 mm), such an operation shall not be accepted as pinch position setting.

While the above embodiment has been explained based on a case in which a portable type information processing device is used, the present invention is not limited to this, and it is also applicable to tables, laptop computers and desktop computers or the like.

In this respect, the present invention is not limited to the above-described embodiment but it includes various modified examples. For instance, the above-described embodiment has been explained in details for clearly explaining the present invention while the present invention is not to be limited to a configuration including all of the explained components. It is possible to add, omit or replace a part of the components of the embodiment with other components.

Further, a part or all of the above components, functions, processing units and processing means might be realized through hardware by designing them, for instance, on an integrated circuit. Moreover, the above components or functions might also be realized through software by interpreting and executing programs realizing respective functions by means of a processor. Information such as programs, tables or files realizing the functions can be stored in memories such as flash memories or in storages such as memory cards.

Further, there are shown only control lines and information lines which are deemed to be necessary for explanations, and it is not necessarily the case that all control lines and information lines of products are shown. In reality, it might be considered that almost all components are mutually connected.

### REFERENCE SIGNS LIST

100 . . . information processing device,
113 . . . operation input unit,
114 . . . display unit,
118 . . . touch panel,
160 . . . pinch mark,
201 . . . finger

1. An information processing device, comprising:
a display unit for displaying images,
an operation input unit for inputting user operations, and
a control unit,
wherein when it is detected that a finger of a user has touched the operation input unit, the control unit displays a mark on the detected spot, and
when it is detected that a finger of the user has touched another position different from the position of the mark in a state in which the mark is displayed,
control is performed to magnify a display image of the display unit when the touch position changes in a direction separating from the position of the mark, and to reduce the display image of the display unit when the touch position changes in a direction approaching the position of the mark.

2. The information processing device according to claim 1, wherein the control unit performs control of changing an magnification ratio and a reduction ratio of the display image on the display unit in accordance with an amount of change of the touch position.

3. The information processing device according to claim 1, wherein the control unit performs control of deleting the mark when it is detected that a position of the mark or a vicinity thereof has been touched.

4. The information processing device according to claim 1, wherein when it is detected that a position of the mark or a vicinity thereof has been touched and when it is further detected that the touch position has changed,
the control unit performs control of moving the mark in accordance with changes in touch positions.

5. The information processing device according to claim 4, wherein the control unit performs control to scroll the display image on the display unit in accordance with the change in touch position.

6. The information processing device according to claim 1, wherein the touch for displaying a mark is a tap operation.

7. The information processing device according to claim 1, wherein the touch for displaying a mark is an operation of touching substantially the same position for a predetermined time.

8. The information processing device according to claim 1, wherein the touch for displaying a mark is an operation of touching substantially the same position twice within a predetermined time.

9. An information processing method in an information processing device,
the information processing device comprising a display unit for displaying images and an operation input unit for inputting user operations, the method including
a step of displaying, when it is detected that a finger of a user has touched the operation input unit, a mark at the detected position, and
when it is detected that the finger of the user has touched a position different from the position of the mark in a state in which the mark is displayed
a step of magnifying the display image when the touch position has changed in a direction separating from the position of the mark, and of reducing the display image when the touch position has changed in a direction approaching the position of the mark.

10. A program for making an information processing device execute;
a step of displaying, when it is detected that a finger of a user has touched an operation input unit of the information processing device, a mark at the detected position, and
when it is detected that the finger of the user has touched a position different from the position of the mark in a state in which the mark is displayed,
a step of magnifying the display image when the touch position has changed in a direction separating from the position of the mark, and of reducing the display imaged when the touch position has changed in a direction approaching the position of the mark.
